(19) United States
(12) Patent Application Publication
(10) Pub. No.: US 2007/0250865 A1
(43) Pub. Date: Oct. 25, 2007

(54) SYSTEM AND METHOD FOR SELECTIVELY RECORDING PROGRAM CONTENT FROM A MOSAIC DISPLAY

(76) Inventor: Haig H. Krakirian, Burbank, CA (US)

Correspondence Address: Vista IP Law Group LLP, 2040 MAIN STREET, 9TH FLOOR, IRVINE, CA, 92614, US

(21) Appl. No.: 11/277,347

(22) Filed: Mar. 23, 2006

(51) Int. Cl. H04N 5/445; G06F 13/00; H04N 7/173; G06F 3/00

(52) U.S. Cl. 725/58; 725/88; 725/89; 725/45

(57) ABSTRACT

A broadcast recording system for selectively recording broadcast program content from a mosaic display while continuing to display the mosaic display. The system may include the ability to present a categorized mosaic, program guide information for selected program content, and/or audio associated with selected program content.

### FIELD OF THE INVENTION

The present invention relates generally to broadcast recording systems, and more particularly, to systems and methods for selectively recording program content from a mosaic display while continuing to display the mosaic display.

### BACKGROUND

Cable television and satellite television have become very common over the years, and they allow viewers to choose from a multitude of channels. Viewers may even choose content based on their subject of interest, such as movies, music videos, and sports.

Programming menus allow recording of program content by selecting the appropriate program from a program guide, typically using a remote control. The program is then recorded when the program later airs. These menus may include program information in the form of a menu in addition to a partial picture containing program content playing in one area of the television screen. The viewer selects the desired program content by using the remote control.

Some systems have increased versatility by allowing a viewer to record programs using a digital video recorder (DVR). Such systems allow a user to record two different programs that air at the same time. Viewers can watch and control either program by pressing a button on a remote control that switches between the two channels. More recently, some systems exist that present a broadcast signal to the viewer in the form of a mosaic, with multiple tiles each representing a separate one of a plurality of program contents. These systems allow a viewer to view several programs at the same time, although each program is viewed only as a tile in a mosaic as opposed to being viewed on the entire display area, and there is no audio. In this manner, a viewer can view a baseball game, a favorite drama show, and a news show, all on one screen simultaneously. Some of these systems also allow viewers to select a program from the mosaic for recording. However, once the program is selected for recording, the display then typically shows only the program that was selected for recording. Viewing options are thus limited once the program for recording is selected. Thus, it would be desirable to provide systems and methods for allowing selection of a program content from a mosaic for recording, while still being able to view the entire mosaic.

### SUMMARY OF THE INVENTION

The present invention relates generally to broadcast recording systems, and more particularly, to multiple program content video systems and apparatus and methods for using them. In one embodiment, a user or viewer requests and receives a broadcast signal that is displayed in the form of a mosaic, where each tile of the mosaic typically corresponds to a separate one of a plurality of program contents. This is referred to herein as a mosaic broadcast signal. The user then selects a program content from the mosaic for recording, and is able to continue to view the mosaic while the selected program content is being recorded, typically on a DVR. The selected tile may be highlighted or otherwise emphasized. The mosaic may be a categorized mosaic, and the user may also request and receive program guide information associated with selected tiles of the mosaic, including expanded information such as information associated with future programs on the channels associated with the selected tiles.

The mosaic broadcast signal preferably includes audio signals associated with the program contents, and the audio signal for a selected program content may be played (audibly produced) in response to selection of the tile corresponding to the selected program content, while the mosaic is being displayed, and/or while a program selected for recording is being recorded. In this manner, a user may navigate through the mosaic, selectively hearing the corresponding audio signals, while the mosaic is being displayed, and/or while the program selected for recording is being recorded. The user may at any time select a tile for full-screen viewing, in which case a tuner previously tuned to the mosaic broadcast channel will be tuned to the broadcast channel associated with the selected tile, and the program content associated with that tile will then be displayed in place of the mosaic. A system for carrying out a method of the present invention includes multiple tuners (e.g., a first tuner, and a second tuner), means for receiving the broadcast signals and supplying them to the tuners, a recording device, a display for displaying a video portion of the mosaic broadcast signal as a mosaic of program contents while a selected one of the program contents is being recorded, and means for requesting recording of the selected program content in response to a request from the viewer. The system may also include means for receiving and playing an audio portion of the mosaic broadcast signal corresponding to a selected tile of the mosaic. Any number of additional tuners may be included, for a total of three, four, five, six, seven, eight, nine, ten, or more total tuners. Doing so would allow more programs to be selected for recording and to be actually recorded.

Other aspects and features of the present invention will become apparent from consideration of the following description taken in conjunction with the accompanying drawings.

### BRIEF DESCRIPTION OF THE DRAWINGS

FIG. 1 is an example of a mosaic display.

FIG. 2 is a flowchart showing a method of selectively recording broadcast program content from a mosaic.

FIG. 3 is a flowchart showing a method of providing a broadcast signal for selectively recording broadcast program content from a mosaic.

FIG. 4 is a block diagram showing hardware embodying the present invention.

FIG. 5 is a flowchart showing a method of playing audio associated with a mosaic.

FIG. 6a illustrates a sample format of a mosaic broadcast signal.

FIG. 6b illustrates a data file corresponding to the mosaic signal of FIG. 6a.

### DETAILED DESCRIPTION OF THE PREFERRED EMBODIMENTS

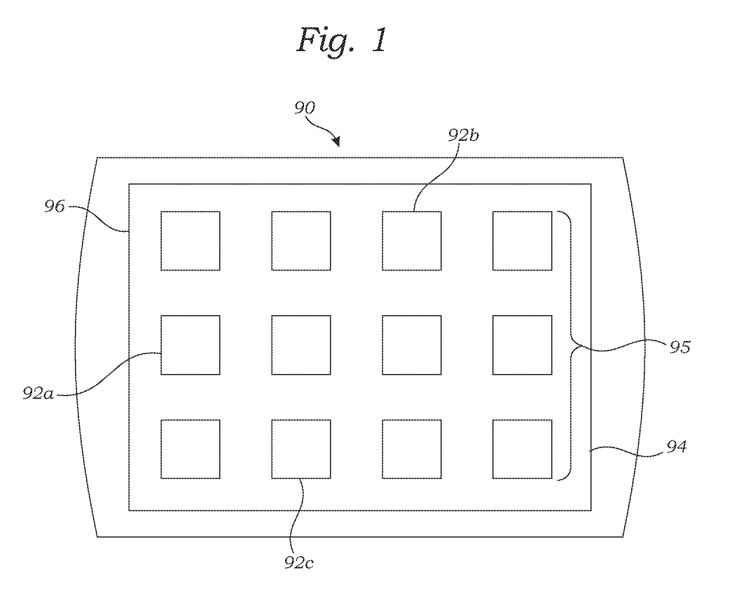

Turning to FIG. 1, shown is a display device 90 including a frame 96, and a screen/display 94 displaying a mosaic 95 having individual tiles including tile 92a, tile 92b and tile 92c. Although a tile typically refers to a physical location on the mosaic 95, “program content” and “tile” may be used interchangeably because the tiles 92 are typically used to display program contents. The display 94 may be a cathode ray tube, a high definition flat screen, a plasma display screen, or another screen suitable for displaying video portions of broadcast signals to be processed in accordance with the present invention as herein described.

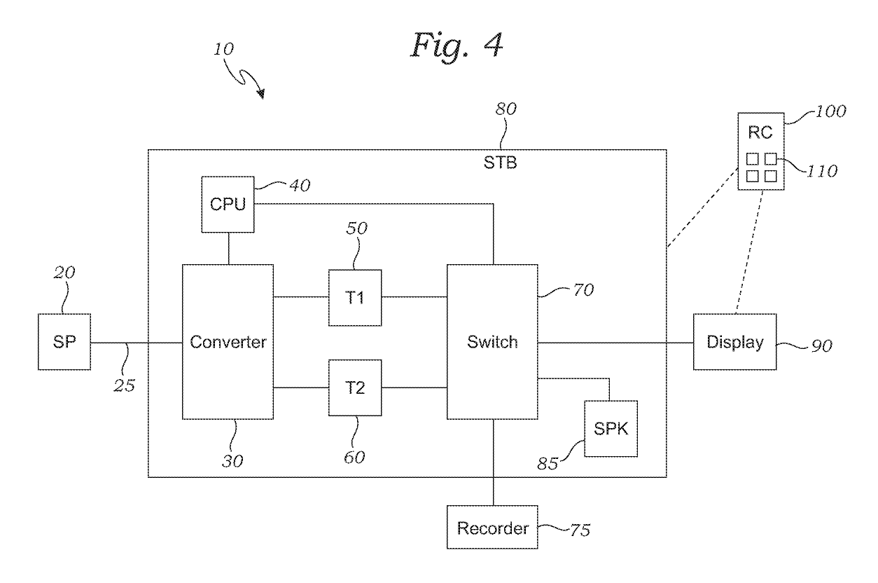

Display 94 comprises a medium to display discrete multiple program content videos as tiles 92 (i.e., at the locations of the tiles 92), each representing a corresponding program content. The display 94 displays the multiple tiles 92 in the form of a mosaic 95. For example, a viewer watching the screen 94 may view a news channel on one tile 92a while viewing a sports channel on tile 92b and a movie channel on tile 92c. The viewer typically navigates through the mosaic 95 with the use of a remote control 100 (FIG. 4). The viewer can select any tile 92 for selected actions, e.g., for recording, filling the whole screen, obtaining program information, obtaining audio information, etc.

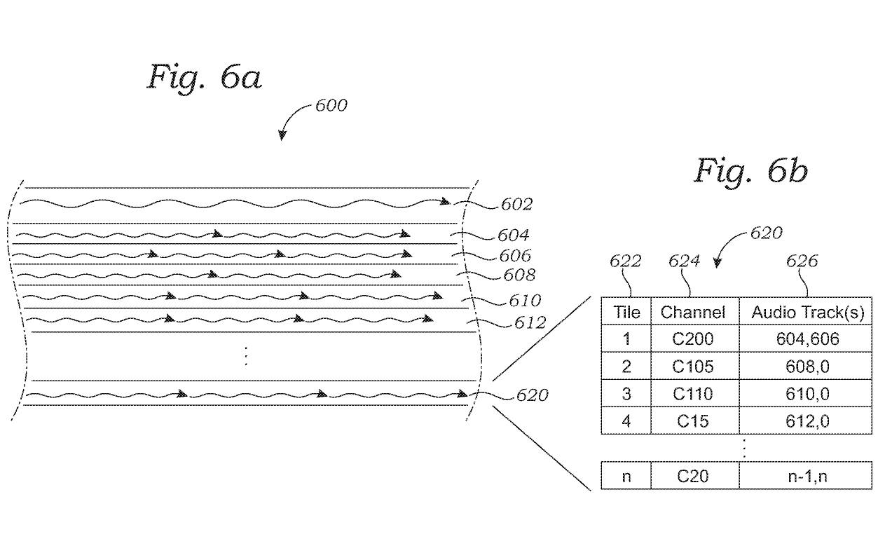

A sample format of a mosaic broadcast signal is shown in FIG. 6a. The mosaic broadcast signal 600 includes a video portion 602, and multiple audio portions 604, 606, 608, 610, 612, . . . The signal 600 may also include a data file 620, or the data file 620 may exist as a separate out-of-band signal, in which case a separate tuner could be used to receive it. The data file 620 includes data as represented in FIG. 6b (referred to there as 620 as well).

Turning to FIG. 6b, the data file 620 is used to associate tiles 92 (column 622) with specific broadcast channels (column 624) and specific audio tracks (column 626). The specific tiles are represented in FIG. 6b as simple sequential tile numbers 1 through n, but the actual data is sufficient to identify the specific tile selected. For example, the data may be screen coordinates mapped to the location of the tiles on the display, so that when a user selects a tile at specific coordinates on the display, those coordinates may be matched to the data in column 622 of the data file 620 to identify the selected tile and thus its associated channel (column 624) and audio track (column 626) information. In this manner, the correct broadcast signals corresponding to selected tiles may be identified and processed accordingly, and the correct audio signals from the mosaic broadcast signal may be identified and processed accordingly.

The audio track information may have a single entry for each tile, or multiple entries for some or all tiles. In the example of FIGS. 6a and 6b, each tile has two entries for audio tracks. This layout may be used for situations wherein a single channel has multiple audio tracks associated with it, such as the case in which a channel has an English language and a Spanish language audio. The first data row in FIG. 6b shows this situation, in which both tracks 604 and 606 are associated with channel C200. The second, third, and fourth data rows of FIG. 6b corresponding to tiles 2, 3, and 4 respectively, and channels C105, C110, and C15 respectively, each have a first audio track 608, 610, 612 respectively, but all show a zero as the second audio track. This is simply a notation to show that these channels do not have a second audio track associated with them.

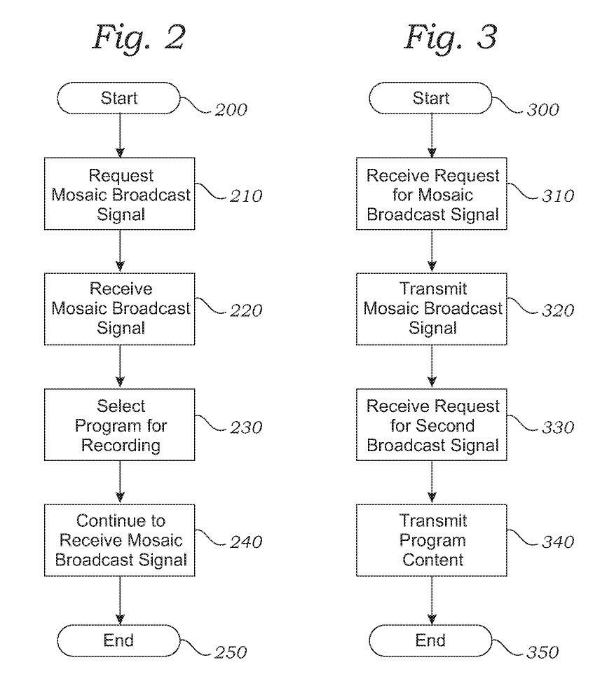

The overall operation of a method will now be briefly described with reference to the operational flow charts shown in FIGS. 2 and 3, and will then be described in more detail. Turning to FIG. 2, an operational flowchart is shown for a method of selectively recording broadcast program content from a mosaic. This method describes the process from the perspective of a viewer/end user, or the system used by the viewer/end user. The method begins at step 200. At step 210, a mosaic broadcast signal is requested, and at step 220 the signal is received. A program is selected for recording at step 230, and at step 240 the mosaic broadcast signal continues to be displayed as a mosaic while the selected program is being recorded. The method ends at step 250. A method from the perspective of a broadcast signal provider or the system used by the broadcast signal provider is shown in FIG. 3. The method begins at step 300. At step 310, a request for a mosaic broadcast signal is received, and at step 320 the broadcast signal is transmitted. A request for a second signal (i.e., the signal corresponding to the program the user selected for recording) is received at step 330, and at step 340 the requested second signal is transmitted for recording such that it can be recorded while the mosaic continues to be displayed. The method ends at step 350.

A detailed operation of the method embodied in FIG. 2 and FIG. 3 will now be described with reference to FIG. 1, an example of a mosaic display 95, and to FIG. 4, a block diagram showing hardware embodying the present invention.

Turning to FIG. 2, the method begins at step 200. At step 210, the mosaic broadcast signal is requested, which contains a plurality of program contents. The mosaic signal may be in MPEG format as is known in the art. An example format of the mosaic signal is shown in FIG. 6 and described herein in connection with FIG. 6. The requested mosaic broadcast signal is received at step 220, and a video portion of the broadcast signal is displayed on a display 94 as a mosaic 95 of the plurality of program contents 92. Each tile 92 of the mosaic 95 contains/displays a video portion of a separate broadcast channel. At step 230, the user selects a program content 92 from the mosaic 95 for recording. At step 240, the broadcast signal continues to be received and/or displayed as a mosaic while the selected program content 92 is being recorded.

The selection of a program or tile occurs by the user navigating through the mosaic 95, e.g., by using control keys 110 (FIG. 4) on a remote control 100 or other suitable device, and then selecting the desired tile 92 using a suitable command such as “enter” or “select”. During navigation of the mosaic 95, each tile 92 may be highlighted or otherwise emphasized as it is passed over, to indicate to the user that the tile 92 is ready for selection or other action. Emphasis may cause the tile 92 to be enlarged partially or fully fill the screen 94, or may cause a colored frame to surround the selected tile 92. Once the desired tile 92 is indicated, the user may then select the tile to perform an action on that tile 92. For example, the action might be recording, enlarging to fill the whole screen 94, obtaining program information, or obtaining audio information The selection may cause the tile to be further emphasized, or emphasized in a distinct manner as compared to when the tile is simply indicated. Examples of further emphasis include causing a border on the highlighted tile to blink, or become offset, or to have a “lock” or “record” icon associated with the tile, or to be graphically altered, or to change color, shape, size, dimensions, etc..

Referring back to step 210, and in connection with FIG. 4, a viewer requests a mosaic broadcast signal, typically from a service provider 20. The viewer's request causes a tuner (T1) 50 to be tuned to a channel associated with the mosaic broadcast signal. The mosaic broadcast signal comprises a plurality of program contents 92 that are displayed as a mosaic 95. For example, display 94 (FIG. 1) shows a mosaic 95 comprising twelve separate tiles 92. Each tile 92 is associated with a separate channel of program content, e.g., a sports channel, a news channel, a movie channel, etc. The request at step 210 may also be made by the viewer using front panel push buttons (not shown) on the front of set top box 80. The request at step 210 may include requesting a broadcast signal in the form of a categorized mosaic 95, wherein the mosaic signal would comprise a plurality of program contents 92 from service provider 20 having a common theme, e.g. sports theme, news theme, or movies theme. Typically, this request is for a predetermined channel set by the service provider 20. For example, channel 70 may be a sports mosaic channel, in which case the user would request channel 70 to receive the sports mosaic. At step 220, the mosaic broadcast signal is received. This is described in more detail herein with respect to FIG. 4.

Now continuing to step 230, a viewer selects one of the plurality of program contents from the mosaic 95 for recording. The selection 230 is typically with the viewer's use of a remote control 100 comprising navigating the tiles 92 of the mosaic 95. Navigating may include using cursor control commands on remote control 100 to position a cursor (not shown) on a selected tile 92, or to otherwise indicate the tile. Selection 230 is also contemplated by a viewer using front panel push buttons (not shown) on display device 90. The viewer selects one of the plurality of program contents from the mosaic 95 for recording by designating the tile 92 of the mosaic 95 associated with the desired program content, and then issuing a “record” command”. This causes a second tuner 60 (FIG. 4) to be tuned to a channel associated with the program selected for recording, and also causes a recording device 75 to record the desired signal. The mosaic signal, coming in on the first tuner 50, continues to be displayed.

In a system with additional tuners, additional tiles 92 may be selected for recording, and doing so would cause one of the available additional tuners (i.e., one that is not already allocated to a signal selected for recording) to be tuned to a channel associated with the additional program selected for recording, and also cause a recording device to record the additional signal. The recording device may be the same device recording other signals, or multiple recording devices may be used if necessary. In either case, the system manages the available resources of tuners and recording devices to ensure that the signals selected for recording are recoded, or if the resources are not available then the system may provide an appropriate indication to the user of that condition, and allow the user to choose how to proceed, such as by canceling one of the previously selected recordings.

Still referring to step 230, a viewer may request to display program guide information associated with a selected program content 92. For example, the viewer may request date, time and duration information for the selected program content 92. The program guide information is displayed on the screen in text or is audibly produced through a speaker 85 associated with the display device 90. The program guide information may be presented in an expanded format, such as being enlarged to fill a portion of the screen 94 up to and including the entire screen 94, or being presented in a drop down, pull-down, or pop-up menu, numbered list, or other suitable manner. Another expanded format comprises displaying program guide information of future programs for the channel associated with the selected program content 92, in which case the information typically could be viewed on a timeline using cursor controls, so a viewer can go through forward programming information for a tile 92 of the mosaic 95.

In another feature of the method associated with step 230, an audio signal associated with a selected program content is received and played upon selection of the corresponding tile 92, and the audio signal is played while the mosaic 95 is being displayed and while a selected program is being recorded. The program being recorded may be the same or different from the program tile 92 selected for audio play. Typically, the audio signal is played by a speaker 85 associated with the display device 90. Similarly, as the user navigates the mosaic 95, an audio signal associated with each tile 92 may be played upon indication and/or selection of the respective tile 92, to replace the audio signal previously being played for the previously indicated/selected tile. The correct audio is determined by matching the selected tile from the video portion of the mosaic broadcast signal to the corresponding audio signal using the information available in the mosaic broadcast signal as shown in FIGS. 6a and 6b and described herein in conjunction with FIGS. 6a and 6b. Each such audio signal is played while the mosaic 95 is being displayed and while the selected program 92 is being recorded.

In another feature, the viewer may select a tile 92 of the mosaic 95 for full-screen or enlarged display, and in response a video portion of a broadcast signal associated with the selected tile is displayed in place of the mosaic, while this selected program or another continues to be recorded. The viewer may alternatively switch back and forth between viewing the mosaic and the program being recorded (or another program) by selecting the desired channels for video display.

As seen at step 240, typically the video portion of the mosaic broadcast signal continues to be received and/or displayed on the display 94 as a mosaic 95, while the selected program content 92 is being recorded. As described herein, however, other channels may also be displayed while the selected program is being recorded, including a channel associated with the program being recorded, a channel associated with one of the other tiles of the mosaic, or any other channel.

Turning now to FIG. 3, an operational flowchart is shown for a method of providing a broadcast signal for selectively recording broadcast program content from a mosaic. The method begins at step 300. At step 310, a service provider 20 receives a first request for a mosaic broadcast signal comprising a plurality of program contents. The request typically comes from a viewer's set top box 80 over transmission line 25 (such as a coaxial or fiber optic cable). The request may be for a specific broadcast signal preset by the service provider, or for a dynamically generated broadcast signal based on user criteria and/or service provider criteria, as discussed herein. The service provider 20 then processes the request and generates the requested broadcast signal accordingly, comprising information formatted to be displayed as a mosaic 94 wherein each of the plurality of program contents 92 is represented by a separate tile 92. The broadcast signal contains information for each of the program contents comprising video, program guide, and audio information. The information in the broadcast signal may be produced and formatted as shown in FIG. 6. Typically, the broadcast information originates from content providers, e.g., television stations, cable television providers, and satellite television providers.

At step 320, the service provider transmits the mosaic broadcast signal formatted for a video portion thereof to be displayed as a mosaic, typically over the transmission line 25 using broadband technology, satellite transmission, or the like. The signal includes an audio portion comprising audio signals associated with each of the plurality of program contents such that an audio signal associated with a selected one of the programs can be played in response to selection of that program content from the mosaic, while the mosaic is being displayed.

At step 330, a request is received for another broadcast signal, corresponding to one of the plurality of program contents from the mosaic to be recorded. Again, the request is typically over transmission line 25. This request may be separate from or in combination with the request for the mosaic broadcast signal. The request received by service provider 20 may include a request for program guide information associated with the selected program content 92 and/or associated with other program content. The program guide information is requested in various formats including current program guide information, and in an expanded format wherein the request comprises program guide information of future programs for the selected program content channel. Optionally, step 330 comprises service provider 20 receiving a request for an audio signal associated with the selected program content 92 or associated with another program content.

In response to the request received at step 330, at step 340 the provider 20 transmits the selected program content 92 (typically from one of many media outlets or from media storage units residing with the service provider 20) for recording, so that the selected program content may be recorded while the mosaic broadcast signal is being displayed as the mosaic 94. This transmission may include service provider 20 transmitting program guide information and/or audio signals.

A request for a mosaic broadcast signal may be for a specific broadcast signal preset by the service provider, or for a dynamically generated broadcast signal based on user criteria and/or service provider criteria. For example, a request for a preset mosaic broadcast signal might occur by a user selecting a channel from the guide labeled “mosaic football,” which the service provider has preset to include all football programs available. On the other hand, that same request may actually be for a dynamically created mosaic broadcast signal (unbeknownst to the user), because the service provider may not have a preset mosaic, but instead may create the mosaic only upon receiving the request for the “mosaic football” channel, at which time the service provider would search for all “football” programs and then create the football mosaic signal accordingly. In a like manner, dynamically created mosaic broadcast signals could be created by the service provider based on any number or combination of user-selected criteria. For example, a user may request a channel from the guide labeled “custom mosaic,” in which case the user could then enter criteria such as genre, rating, actor(s), producer(s), recommendation status, and the like, and the service provider would then dynamically (i.e., in response to the request) create the custom mosaic broadcast signal.

Turning now to FIG. 4, illustrated is a block diagram showing hardware 10 embodying the present invention. The system includes: a first tuner 50 (typically tuned to a first channel associated with a mosaic broadcast signal); a second tuner 60 (typically tuned to a second channel associated with a broadcast signal being recorded); means for receiving the first broadcast signal and supplying the first broadcast signal to the first tuner (e.g., transmission line 25, converter 30, CPU 40, common circuitry, and equivalents); means for receiving the second broadcast signal and supplying the second broadcast signal to the second tuner (e.g., transmission line 25, converter 30, CPU 40, common circuitry, and equivalents); a display device 90 for displaying a video portion of the first broadcast signal as the mosaic, while the second broadcast signal is being recorded; a recording device 75 (e.g., a DVR, VCR, or other recording device); and means for requesting recording of the second broadcast signal on the recording device 75 in response to a request from a viewer (e.g., remote control 100). System 10 typically also includes means for receiving and playing an audio portion of the mosaic broadcast signal and/or other broadcast signals corresponding to selected tiles of the mosaic (e.g., speaker 85).

A sample use of the system of FIG. 4 will now be described in connection with FIG. 1. Typically, a viewer makes a request for the mosaic broadcast signal using a remote control 100. The set top box 80, through operation controlled by central processing unit (CPU) 40, transmits the viewer's request to service provider 20 using transmission line 25. Upon receipt of the viewer's request, service provider 20 transmits the requested mosaic broadcast signal to the set top box 80 using transmission line 25. The mosaic broadcast signal is received by converter 30 in set top box 80, which couples the broadcast signal to tuner (T1) 50. CPU 40 operates to cause switch 70 to pass the video broadcast from tuner (T1) 50 to display 90, where a video portion of the broadcast signal is displayed as a mosaic 95. As described herein, the mosaic 95 comprises a plurality of program contents 92 each represented by an individual tile 92.

The viewer then observes the mosaic 95 and navigates from tile 92a to tile 92b using remote control 100, each tile being indicated as it is passed over during navigation. In this way the viewer may select a particular indicated tile 92 of the mosaic 95 for recording or for another action. To record the program content associated with the indicated tile, the viewer selects the “record” option displayed on screen 94 or selects the “record” option on remote control 100, and this causes tuner 60 to tune to the channel associated with the selected tile. When service provider 20 receives a request for the selected program content 92 to be recorded, service provider 20 transmits the selected program content via transmission line 25 through converter 30, which passes the selected program content through tuner 60 to switch 70, and switch 70 then couples the selected program content from tuner (T2) 60 to recorder 75. Display device 90 continues to display the mosaic 95 while the selected program content 92 is being recorded.

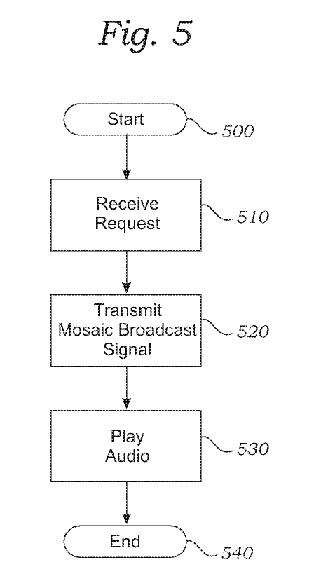

In yet another feature of the invention, FIG. 5 shows a method of playing audio associated with a mosaic 95. The method begins at step 500. At step 510, service provider 20 receives a request for a mosaic broadcast signal having audio information associated with the plurality of program contents 92. At step 520, service provider 20 transmits the broadcast signal formatted to be displayed in the form of a mosaic 95, and including the audio signals. At step 530, the audio information for a selected one the plurality of program contents 92 is played while the mosaic 95 is being displayed.

Elements or components shown with any embodiment herein are exemplary for the specific embodiment and may be used on or in combination with other embodiments disclosed herein. Specific examples of the invention have been shown in the drawings and described herein. It should be understood, however, that the invention is not to be limited to the particular forms or methods disclosed, and is to cover all modifications, equivalents and alternatives falling within the scope of the appended claims.

What is claimed is:

1. A method of selectively recording broadcast program content comprising:
requesting a broadcast signal comprising a plurality of program contents, said plurality of program contents comprising a first program content and a second program content;
receiving the broadcast signal, a video portion of the broadcast signal being displayed on a display as a mosaic of the plurality of program contents;
selecting the second program content from the mosaic for recording; and
continuing to receive the broadcast signal while the second program content is being recorded, the video portion of the broadcast signal continuing to be displayed on the display as the mosaic while the second program content is being recorded.

2. The method of claim 1, wherein requesting the broadcast signal comprises requesting a categorized mosaic.

3. The method of claim 1, further comprising requesting to display program guide information associated with the second program content.

4. The method of claim 3, further comprising requesting the program guide information to be displayed in an expanded format.

5. The method of claim 4, wherein the expanded format comprises information about a future program for a broadcast channel associated with the second program content.

6. The method of claim 1, further comprising requesting to display program guide information associated with the first program content.

7. The method of claim 6, wherein the request to display the program guide information comprises selecting a tile of the mosaic associated with the first program content.

8. The method of claim 7, further comprising requesting the program guide information to be displayed in an expanded format comprising information about a future program for a broadcast channel associated with the first program content.

9. The method of claim 1, wherein the broadcast signal comprises an audio portion comprising audio signals associated with each of the plurality of program contents respectively, further comprising selecting a first tile of the mosaic associated with the first program content, and wherein a first audio signal associated with the first program content is played in response to selection of the first tile, while the mosaic is being displayed and while the second program content is being recorded.

10. The method of claim 9, wherein the plurality of program contents comprises a third program content, further comprising selecting a third tile of the mosaic associated with the third program content, after selecting the first tile, and wherein a third audio signal associated with the third program content is played in response to selection of the third tile and in place of the first audio signal, while the mosaic is being displayed and while the second program content is being recorded.

11. The method of claim 10, wherein selecting the third tile causes the third tile to be emphasized on the display.

12. The method of claim 10, wherein selecting the third tile comprises navigating the mosaic.

13. The method of claim 9, wherein selecting the tile causes the tile to be emphasized.

14. The method of claim 1, wherein the second program content is recorded on a DVR.

15. The method of claim 1, wherein requesting the broadcast signal causes a first tuner to be tuned to a broadcast channel associated with the broadcast signal, and wherein selecting the second program content for recording causes a second tuner to be tuned to a broadcast channel associated with the second program content.

16. The method of claim 1, further comprising selecting a tile of the mosaic associated with the first program content, causing a video portion of a broadcast signal associated with the first program content to be displayed in place of the mosaic, while the second program content is being recorded.

17. The method of claim 1, wherein selecting the second program content for recording comprises selecting a tile of the mosaic associated with the second program content.

18. The method of claim 1, wherein the broadcast signal is preset.

19. The method of claim 1, wherein the broadcast signal is dynamically created.

20. The method of claim 19, wherein the broadcast signal is dynamically created as a custom mosaic broadcast signal based on user criteria.

21. A method of playing audio signals associated with program contents displayed on a display in the form of a mosaic comprising:
receiving a request for a broadcast signal comprising a plurality of program contents;
transmitting the broadcast signal formatted for a video portion thereof to be displayed in the form of a mosaic on the display, the broadcast signal further comprising an audio portion comprising audio signals associated with each of the plurality of program contents such that an audio signal associated with a first of the plurality of program contents may be played in response to selection of the first program content from the mosaic, while the mosaic is being displayed.

22. The method of claim 21, further comprising receiving a request for a second broadcast signal corresponding to a selected one of the plurality of program contents to be recorded, and sending the second broadcast signal in response thereto.

23. A method of providing a broadcast signal for selectively recording broadcast program content from a mosaic comprising:
receiving a first request for a first broadcast signal comprising a plurality of program contents;
transmitting the first broadcast signal formatted to be displayed as a mosaic comprising a plurality of tiles, each of the plurality of tiles being associated with a corresponding one of the plurality of program contents;
receiving a second request for a second broadcast signal corresponding to a selected one of the plurality of program contents from the mosaic to be recorded; and
transmitting the second broadcast signal so that the selected program content may be recorded while the first broadcast signal is being displayed as the mosaic.

24. The method of claim 23, further comprising receiving a request for program guide information associated with the selected program content, and transmitting the program guide information for display.

25. The method of claim 23, wherein the first broadcast signal comprises an audio portion comprising audio signals associated with each of the plurality of program contents respectively.

26. A system for viewing and selectively recording broadcast content comprising:
a first tuner tuned to a first channel associated with a first broadcast signal comprising a plurality of program contents including a first program content and a second program content, said first broadcast signal being formatted for display as a mosaic comprising a plurality of tiles each associated with a separate one of the plurality of program contents respectively;
a second tuner tuned to a second channel associated with a second broadcast signal comprising the second program content;
means for receiving the first broadcast signal and supplying the first broadcast signal to the first tuner;
means for receiving the second broadcast signal and supplying the second broadcast signal to the second tuner;
a display for displaying a video portion of the first broadcast signal as the mosaic, while the second broadcast signal is being recorded;
a recording device; and
means for requesting recording of the second broadcast signal on the recording device in response to a request from a viewer.

27. The system of claim 26, further comprising means for alternatively displaying on the display the video portion of the first broadcast signal and a video portion of the second broadcast signal, while the second broadcast signal is being recorded.

28. The system of claim 26, further comprising means for receiving and playing an audio portion of the first broadcast signal corresponding to a selected tile of the mosaic.

29. The system of claim 26, wherein the plurality of program contents further includes a third program content, the system further comprising:
a third tuner tuned to a third channel associated with a third broadcast signal comprising the third program content;
means for receiving the third broadcast signal and supplying the third broadcast signal to the third tuner; and
means for requesting recording of the third broadcast signal on the recording device in response to a request from the viewer.
